(19) United States
(12) Patent Application Publication
(10) Pub. No.: US 2026/0134388 A1
(43) Pub. Date: May 14, 2026

(54) SYSTEM AND METHOD FOR LOADING A CONTAINER

(71) Applicant: KoiReader Technologies, Inc., Dallas, TX (US)

(72) Inventors: Ashutosh Prasad, Dallas, TX (US); Vivek Prasad, Bengaluru (IN)

(21) Appl. No.: 19/105,155

(22) PCT Filed: Aug. 22, 2023
(86) PCT No.: PCT/US2023/030804

§ 371 Date: Feb. 20, 2025

Related U.S. Application Data
(60) Provisional application No. 63/373,234, filed on Aug. 23, 2022.

(51) Int. Cl. G06Q 10/087; B65G 1/137

(52) U.S. Cl. CPC G06Q 10/08741; B65G 1/1375

(57) ABSTRACT

Techniques are described for generating stacking orders and pull orders associated with arranging assets on or within a transport handling unit or other type of shipping container. In some cases, the system may determine a stacking order for an autonomous stacking system based on data associated with the transport vehicle, the assets, and the like in order to fulfill requirements associated with particular types of transport, such as airfreight.

### CROSS-REFERENCE TO RELATED APPLICATIONS

This application is a U.S. national stage application under 35 USC § 371 of International Application No. PCT/US23/30804 filed on Aug. 22, 2023 which claims priority to U.S. Provisional Application No. 63/373,234, filed on Aug. 23, 2022 the entirety of which are incorporated herein by reference.

### BACKGROUND

Storage facilities, such as shipping yards, processing plants, warehouses, distribution centers, ports, yards, transports, and the like store vast quantities of assets over a period of time. These assets are often stacked or combined on containers, pallets, and the like prior to loading into a transport vehicle. The facility is often required to stack or load the containers in a particular order to ensure weight limits are not exceeded and that the assets are not damaged during transit. This process is often time consuming and requires processing each asset to determine a weight and/or size prior to initiating the stacking process, which is time consuming and inefficient.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is an example block diagram of an asset management system for assisting with arranging asset for loading on a transport vehicle.

FIG. 2 is a flow diagram illustrating an example process associated with arranging asset for loading on a transport vehicle according to some implementations.

FIG. 3 is another flow diagram illustrating an example process associated with arranging asset for loading on a transport vehicle according to some implementations.

FIG. 4 is an example sensor system that may implement the techniques described herein according to some implementations.

FIG. 5 is an example asset management system that may implement the techniques described herein according to some implementations.

### DETAILED DESCRIPTION

Discussed herein is a system for loading and stacking assets stored in a facility (such as a warehouse, yard, or the like) in preparation for transport. For instance, the loading of a transport handling unit (THU) is often required to be performed in a particular order and maintain a particular weight and/or size based on the type of transportation vehicle. As an illustrative example, an airfreight may be required to maintain a particular weight requirement and stacked in an order to ensure the assets loaded on the THU are not damaged. As discussed herein, a THU may include, but is not limited to, as pallets, bins, unit load devices (ULDs), ocean containers, airfreight units, any object that may carry or otherwise transport an inventory item, and the like.

In some implementations, discussed herein, an asset management system 102 may be configured to track and monitor assets as the assets are loaded/unloaded and/or moved about the facility. For example, an asset management system, discussed herein, may include, but not be limited to, an inventory management system, a chain of custody system, a warehouse management system, an asset management system, facility management system, a supply chain management system, a container inventory management system, and/or the like. The asset management system may be a remote or cloud-based system that is communicatively coupled to a plurality of sensor systems located at various facilities, vehicles, containers, and the like.

As the assets are received and moved about the facility, the asset management system may determine features associated with each individual assets, such as type, identity, location, size, bounding boxes, dimensions, estimated weight, and the like using various sensors system associated with a forklift, transport vehicles, fixed facility sensor, worn sensor systems and the like. The features may be stored by the asset management system 102 and accessible via an operator, third-party, and the like.

When a THU is being prepared for loading onto a transport vehicle, the asset management system may access the stored features of the assets being shipped. The asset management system may then determine a pull order and/or a stacking order and/or THU arrangement for each individual THU being loaded based at least in part on the features of the assets and the recruitments of the transportation vehicle (such as gate size, cargo size, weight capacity, and the like).

In some cases, the asset management system may send the pull order (e.g., the order in which to collect the assets from a storage area) to an operator and/or autonomous collection vehicle (such as an autonomous forklift). In this manner, the assets may be delivered to the staging and/or stacking area in an order that the assets are to be loaded onto the THU. The asset management system may also send the stacking order to a stacking system. For example, the stacking system may be an autonomous or semi-autonomous robotic system including one or more arms and/or implements capable of grasping the assets and placing them on the THU. In this manner, as the assets are delivered to the staging area, the stacking system may select, grasp, and move the assets onto the THU such that the assets are stacked correctly, the THU are within a dimensional threshold or bounding box, and the THU remains below a weight threshold.

In some cases, the asset management system may predetermine the pull order and/or the stacking order prior to initiating the loading of the THU. For example, the asset management system may perform the processing associated with determining the pull order and/or the stacking order overnight while the computational resources of the asset management system are otherwise typical underutilized. In some cases, the asset management system may also generate a build schematic that may be sent to approval by, for instance, a facility management, a transport authority, government agency, and/or the transport company handling the delivery, prior to sending the pull order and/or the stacking order to the respective operator/vehicle and/or stacker system.

In this manner, the asset management system may reduce any delays or down time associated with generating the pull orders, generating the stacking orders, receiving approvals, receiving change requests or orders, and the like. As an illustrative example, in some cases, the stacking system may stack the assets on a THU and the THU may then be inspected by a representative of the transport company. The representative in some cases, may reject the THU which would require unstacking and restacking prior to loading causing confusing and delay.

In some examples, the asset management system may process the data and features using one or more machine learned models to assist with determining a stacking order, pull orders, and approval requests. As described herein, the machine learned models may be generated using various machine learning techniques. For example, the models may be generated using one or more neural network(s). A neural network may be a biologically inspired algorithm or technique which passes input data (e.g., image and sensor data captured by the IoT (Internet of Things) computing devices) through a series of connected layers to produce an output or learned inference. Each layer in a neural network can also comprise another neural network or can comprise any number of layers (whether convolutional or not). As can be understood in the context of this disclosure, a neural network can utilize machine learning, which can refer to a broad class of such techniques in which an output is generated based on learned parameters.

As an illustrative example, one or more neural network(s) may generate any number of learned inferences or heads from the captured sensor and/or image data. In some cases, the neural network may be a trained network architecture that is end-to-end. In one example, the machine learned models may include segmenting and/or classifying extracted deep convolutional features of the sensor and/or image data into semantic data. In some cases, appropriate truth outputs of the model in the form of semantic per-pixel classifications and recognition (e.g., vehicle identifier, container identifier, driver identifier, and the like).

Although discussed in the context of neural networks, any type of machine learning can be used consistent with this disclosure. For example, machine learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3(ID 3 ), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, VGG, DenseNet, PointNet, and the like. In some cases, the system may also apply Gaussian blurs, Bayes Functions, color analyzing or processing techniques and/or a combination thereof.

In some examples, a sensor system may be associated with the stacking system, the delivery system (e.g., an autonomous forklift, crane, liftgate, or the like), and/or the facility. The sensor system may include one or more IoT devices. The IoT computing devices may include a smart network video recorder (NVR) or other type of EDGE computing device with a GPU/NPU/CPU. Each IoT device may also be equipped with sensors and/or image capture devices, such as visible light image systems, infrared image systems, radar based image systems, LIDAR based image systems, SWIR based image systems, Muon based image systems, radio wave based image systems, and/or the like. In some cases, the IoT computing devices may also be equipped with models and instructions to capture, parse, identify, and extract information associated with a lifecycle of an asset, as discussed herein, in lieu of or in addition to the cloud-based services. For example, the IoT computing devices and/or the cloud-based services may be configured to perform segmentation, classification, attribute detection, recognition, data extraction, and the like.

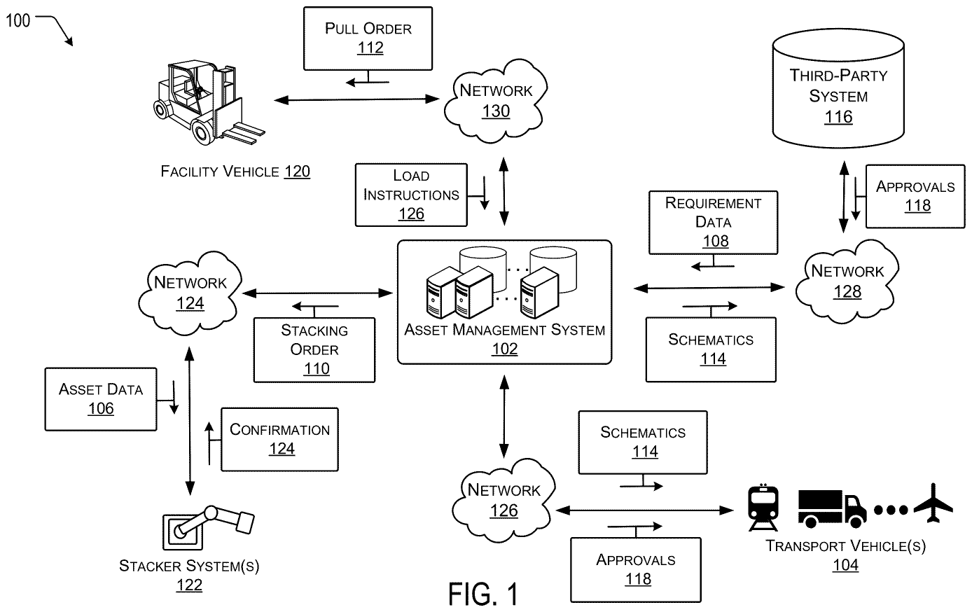

FIG. 1 is an example block diagram 100 of an asset management system 102 for assisting with arranging asset for loading on a transport vehicle 104. In the current example, the asset management system 102 may maintain asset data 106 associated with assets stored at a facility. The asset management system 102 may receive requirement data 108 associated with assets being transported by the transport vehicle 104. The requirements data 108 may include bounding boxes, dimensions, weight limits, and the like associated with individual THU and/or the contents, characteristics, or features of the cargo area of the transport vehicle 104.

The asset management system 102 may then determine a stacking order 110 (e.g., an order of assets for stacking on a THU), a pull order 112 (e.g., an order of which the assets should be collected from storage, shelving, or the like), and a stacking schematic 114 (e.g., a two-dimensional or three-dimensional representation of the stacked assets) associated with each THU to be loaded on the transport vehicle 104 based at least in part on the asset data 106 and/or the requirement data 108. For example, the asset management system 102 may determine which assets to place on which THU and in what order each asset should be stacked or otherwise arranged.

The asset management system 102 may, in some cases, first generate the stacking schematic 114 illustrating which assets associated with a delivery are on which THU and in what order or arrangement. The stacking schematics 114 may be provided to a third-party system 116, such as the party providing the requirements data 108. In this manner, the third-party system 116 may send an approval 118 and/or a disapproval associated with the stacking arrangement determined by the asset management system 102 prior to loading the THU. The asset management system 102 may also send the stacking schematics 114 to a party associated with the transport vehicle 104, such as to notify and/or to seek approval from the driver, manager, and/or operator prior to loading the THU.

If the asset management system 102 receives the approval 118 from the appropriate parties (e.g., the transport vehicle 104 and/or the third-party systems 116), then the asset management system 102 may send the pull order 112 to a facility vehicle 120 to instruct the facility vehicle 120 and/or a device associated with an operator of the facility vehicle 120 to pull the assets in an assigned or designated order. In some cases, the pull order 112 may be sent in response to additional triggers, such as the approval and a detected arrival of the transport vehicle 104, a specific time, specific date, user inputs, and/or the like. In some cases, the facility vehicle 120 may be autonomous. In these cases, the pull order 112 may include instructions to perform operations to collect the assets associated with the pull order 112 from storage or shelving and deposit the assets according ot the pull order 112 at a staging area, such as proximate to a stacker system 122.

The asset management system 102 may also send a stacking order 110 to the stacking system 122. The stacking system 122 may be a robotic or autonomous system configured to stack a THU with the desired assets. In some cases, the asset management system 102 may send the asset data 106 (and/or the requirements data 108) to the stacker system 122 and the stacker system 122 may return the schematics 114 and/or the stacking order 110, such as when the stacker system 122 is designed to configure its own stacking order.

Upon completion of a THU, the stacker system 122 (and/or another sensor system associated with the facility) may send a confirmation 124 to the asset management system 102. In response, the asset management system 102 may send load instructions to the facility vehicle 120 to load the THU onto the transport vehicle 104. In some cases, the asset management system 102 may process sensor data either received from the facility vehicle 120, the transport vehicle 104, and/or a facility sensor system to determine that the THU was properly loaded and transfer custody of the assets to the transport vehicle 104.

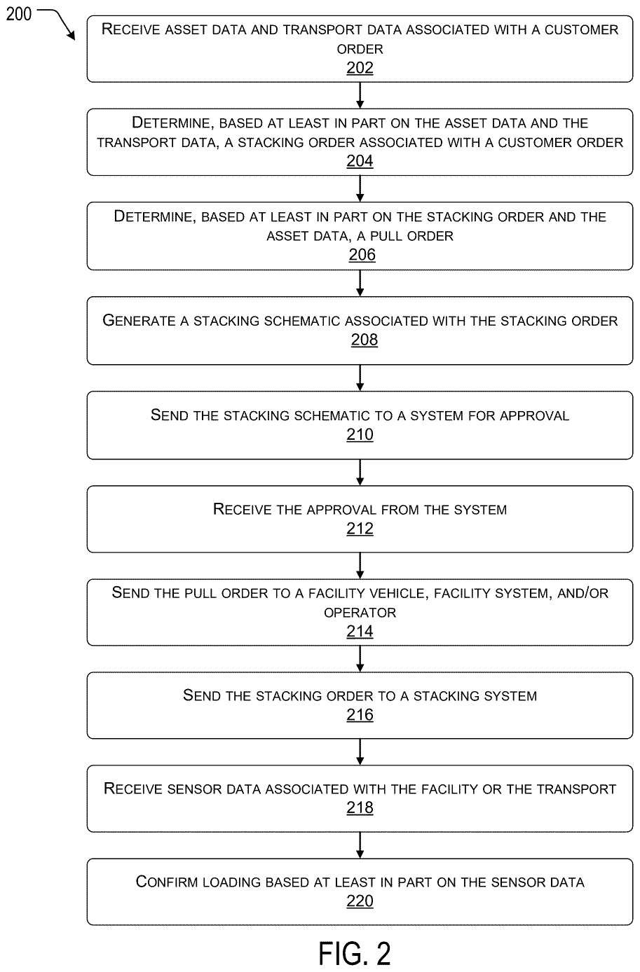

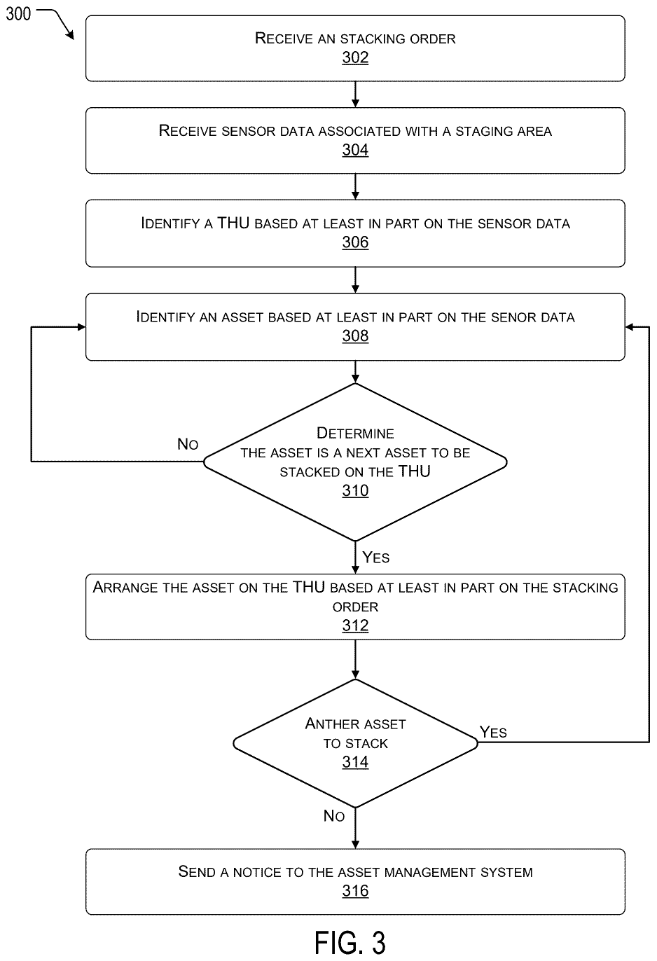

FIGS. 2 and 3 are flow diagrams illustrating example processes associated with the asset management system discussed herein. The processes are illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, when executed by one or more processor(s), performs the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 2 is a flow diagram illustrating an example process 200 associated with arranging asset for loading on a transport vehicle according to some implementations. As discussed above, an asset management system may determine based at least in part on data known about the assets, incoming orders, transportation vehicle schedules, and various reequipments associated with the transportation vehicles an arrangement of assets per THU as well as an arrangement of multiple THUs with respect ot a cargo area of the transport vehicle. In this manner, the transport can be packed efficiently and within requirements (such as clearance, maximum weight, and the like).

At 202, the asset management system and/or the stacking system may receive asset data and transport data. The asset data may be stored in a datastore associated with the management system, such as a local server or remote cloud-based storage. In some cases, the asset data may be received when the asset was unloaded from a transport into the facility via an IoT, EDGE or other sensor system associated with the gate. In other cases, the asset data may be received from a vehicle operating within the facility, such as an autonomous forklift. In still other cases, the asset data may be received via a cloud-based system that transfer a chain of custody or ownership of the asset data from one facility to the next as the assets are moved and relocated. In some cases, as the chain of custody is changed/updated, the asset management system may update the access credentials to allow the receiving facility to access the data as well as block access from the former responsible party.

The transport data may include a schedule of the specific transports arriving at the facility and the time at which each is scheduled to arrive. In some cases, the transport data may include specific identifiers (such as vehicle identification numbers (VIN), license plates, country identifiers, and the like). The transport data may also include requirements (such as maximum weight thresholds, cargo door dimensions, cargo bay dimensions, and the like). In some cases, the transport data may include schedule data and/or routing data of the transport. The schedule data and/or routing data may be updated in substantially real-time. For example, if the transport is delayed, a scheduling system associated with the transport may update the schedule data such that the asset management system and/or the stacking system may update the pull orders and/or the stacking orders, as discussed above, to accommodate the change in arrival time.

The transport data may also include requirement data, such as described above. For example, the requirement data may include dimensions, characteristics, weight capacity, bounding boxes, gate size, features (e.g., cables, straps, shelving, drawers, and the like) associated with a cargo area of the transport vehicle.

At 204, the asset management system and/or the stacking system may determine, based at least in part on the asset data and the transport data, a stacking order associated with a customer order (e.g., the assets required by a customer and associated with the current shipment being fulfilled). For example, the stacking order may determine which assets to place on which THU and in what order each asset should be stacked or otherwise arranged. The stacking order may be based on the asset data, such as dimensions, bounding boxes, weight, and the like, as well as the dimensions of the THU and the transport data, such as the requirements data (e.g., the dimensions of the transport gate, cargo area, weight capacity, and the like).

In some cases, the asset management system and/or stacking system may utilized one or more machine learned models to determine the stacking order. In these cases, the system may input the asset data, the transport data, and/or the requirements data into the machine learned model and receive as an output the stacking order. In some cases, the output may be a stacking order and for each THU that the models determine should be used with respect to the delivery. For instance, the one or more machine learned models (or the asset management system) may determine a number of THUs to use for the delivery and then determine a stacking order for each of the THUs.

At 206, the asset management system and/or the stacking system may determine, based at least in part on the stacking order and the asset data, a pull order. For example, the pull order for a forklift, individual, drone, other autonomous system, or the like to pull the assets from the facility and move them to a staging and/or processing area may be generated based on the stacking order (e.g., the bottom assets may be pulled first) as well as location within the facility as provided in the asset data (e.g., closer assets may be pulled first).

At 208, the asset management system and/or the stacking system may generate a stacking schematic associated with the stacking order. For example, the stacking schematic may illustrate which assets associated with a delivery are on which THU and in what order or arrangement. The stacking schematic may include a list of assets, stack order, total weight, total height, bounding boxes, and a visual (e.g., a CAD or 3D model) of the stacked assets.

In some cases, the asset management system may utilize one or more machine learned models (different from or the same as the one or more machine learned models discussed with respect ot 204 above) to generate the stacking schematic. For example, the system may input the stacking order, the asset data, the transport data, and/or the requirements data into the one or more machine learned models (trained on stacking order, asset data, transport data, and/or requirements data) and receive as an output the stacking schematic.

At 210, the asset management system and/or the stacking system may send the stacking schematic to a system for approval and, at 212, the asset management system and/or the stacking system may receive the approval from the system. For example, the stacking schematics may be provided to a third party system, such as the party providing the transport data. In this manner, the third-party system may send an approval and/or a disapproval associated with the stacking arrangement determined by the asset management system prior to loading the THU. The asset management system may also send the schematics to a party associated with the transport vehicle, such as to notify and/or to seek approval from the driver or operator prior to loading the THU.

At 214, asset management system and/or the stacking system may send the pull order to a facility vehicle (e.g., an autofocus vehicle), a facility system (e.g., a display, speaker, or other system), and/or an operator (e.g., an individual responsible for the pull event).

At 216, in some implementations, asset management system and/or the stacking system may send the stacking order to a stacking system. For example, the stacking system may stack the assets on a THU according to the stacking order upon delivery. In some cases, the stacking schematic may be presented on a display associated with a stacking area and the individual assets may be color coded as the stacking system arranged the assets on the THU. For example, the display may present assets as yellow for unstacked, green for stacked correctly, and/or red for stacked incorrectly. In this manner, a facility operator may be alerted to any issues with the stacking order or stacking schematic prior to loading the THU on the transport vehicle.

At 218, the asset management system and/or the stacking system may receive sensor data associated with the facility or the transport vehicle and, at 220, the asset management system and/or the stacking system confirm loading based at least in part on the sensor data. For example, the sensor data may include data representative of the stacked THU and/or assets being loaded onto the transport. The asset management system and/or the stacking system may then confirm the loading or change in custody based on processing the sensor data.

FIG. 3 is another flow diagram illustrating an example process 300 associated with arranging asset for loading on a transport vehicle according to some implementations. As discussed herein, a stacking system may stack assets in a staging area onto a THU for loading onto a transport vehicle based at least in part on a stacking order.

At 302, the stacking system may receive a stacking order. For example, an asset management system may send the stacking order and/or the stacking system may determine the stacking order. In some cases, the stacking order may determine which assets to place on which THU and in what order each asset should be stacked or otherwise arranged. The stacking order may be based on asset data known about the assets (e.g., asset dimensions, asset bounding boxes, asset weight, and the like) as well as data known about the THU (e.g., the THU dimensions, bounding box, weight, and the like) of the THU and the dimensions of the transport gate, cargo area, weight capacity, and the like. In some cases, the asset management system and/or stacking system may utilized one or more machine learned models to determine the stacking order.

At 304, the stacking system may receive sensor data associated with the staging area. For example, the assets to be stacked may be delivered to a staging area as well as the THU and the sensor data may be representative of the object and environment associated with the staging area.

At 306 and 308, the stacking system may identify a THU and an asset based at least in part on the senor data. For example, the stacking system may utilize one or more sensors and/or one or more machine learned models, associated with a vision system, to capture sensor data, segment the data into objects or features, and classify and/or identify each object or feature. In this manner, the stacking system may identify each object, features of the objects, and a location of each object within a predefined area (e.g., the staging area).

At 310, the stacking system may determine if the asset identified at 308 is the next asset to be stacked on the THU. If the asset is the correct asset (e.g., the next asset) then the process 300 may proceed to 312, if it is not the process 300 may return to 308 and the stacking system may identify another asset. In some cases, the stacking system may determine the asset is the next asset based on an identifier, a wireless signal (such as a Bluetooth signal), one or more features of the object, a label associated with the object, a location of the object, a combination thereof, and/or the like.

At 312, the stacking system may arrange the asset on the THU based at least in part on the stacking order. For example, the asset may be identified, grasped, and then moved onto the assigned position on the THU. In some cases, the assigned position may be adjacent to, over, or both a preceding asset. For instance, the THU may be wide enough to accommodate assets placed adjacent to each other within a row or column as well as on top of each other.

At 314, the stacking system may determine if the there is another asset to stack. If there is another asset then the process 300 may return to 308. Otherwise, the process 300 may advance to 316. At 316, the stacking system may send a notification to the asset management system. the notification may alert the asset management system, facility vehicle, and/or facility operator that the THU is ready for loading onto the transport vehicle and that the stacking system may proceed to the next assignment.

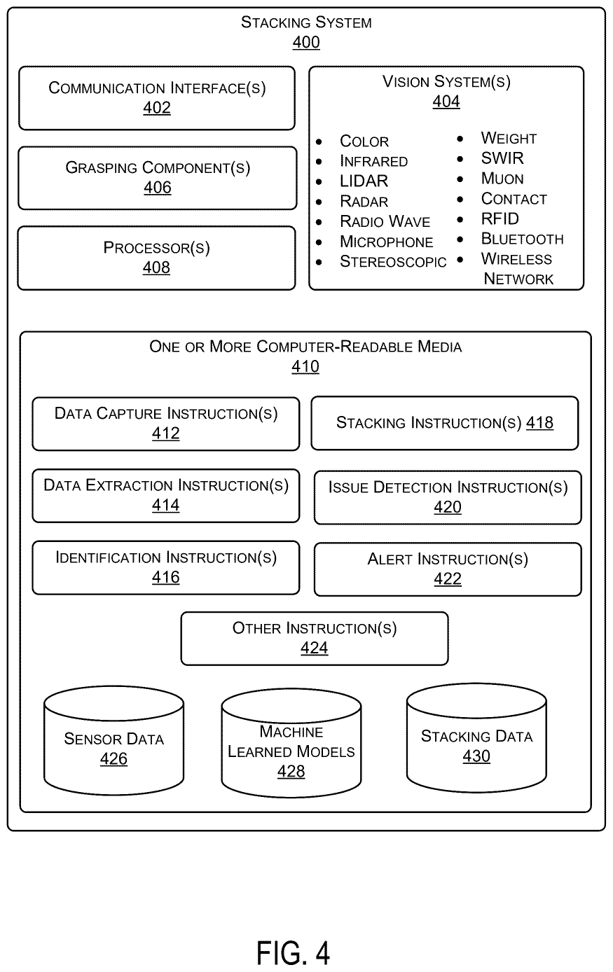

FIG. 4 is an example stacking system 400 that may implement the techniques described herein according to some implementations. The stacking system 400 may include one or more communication interfaces(s) 402 that enable communication between the stacking system 400 and one or more other local or remote computing device(s), such as the asset management system discussed herein. For instance, the communication interface(s) 402 can facilitate communication with other proximity sensor systems, a central control system, or other facility systems. The communications interfaces(s) 402 may enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.), satellite communication, dedicated short-range communications (DSRC), or any suitable wired or wireless communications protocol that enables the respective computing device to interface with the other computing device(s).

The one or more sensor(s) 404 may be configured to capture the sensor data 426 associated with assets. In at least some examples, the sensor(s) 404 may include thermal sensors, time-of-flight sensors, location sensors, LIDAR sensors, SWIR sensors, radar sensors, sonar sensors, infrared sensors, cameras (e.g., RGB, IR, intensity, depth, etc.), Muon sensors, microphone sensors, environmental sensors (e.g., temperature sensors, humidity sensors, light sensors, pressure sensors, etc.), 5G or other wireless sensors, and the like. In some examples, the sensor(s) 804 may include multiple instances of each type of sensor. For instance, camera sensors may include multiple cameras disposed at various locations.

The stacking system 400 may also include one or more grasping component 406. For example, the stacking system 400 may include one or more robotic arms or manipulators that may be configured to apply pressure to one or more sides of an asset in order to grasp and move the asset from a first location to a second location.

The stacking system 400 may include one or more processors 408 and one or more computer-readable media 410. Each of the processors 408 may itself comprise one or more processors or processing cores. The computer-readable media 410 is illustrated as including memory/storage. The computer-readable media 410 may include volatile media (such as random access memory (RAM)) and/or nonvolatile media (such as read only memory (ROM), Flash memory, optical disks, magnetic disks, and so forth). The computer-readable media 410 may include fixed media (e.g., GPU, NPU, RAM, ROM, a fixed hard drive, and so on) as well as removable media (e.g., Flash memory, a removable hard drive, an optical disc, and so forth). The computer-readable media 410 may be configured in a variety of other ways as further described below.

Several modules such as instructions, data stores, and so forth may be stored within the computer-readable media 410 and configured to execute on the processors 408. For example, as illustrated, the computer-readable media 410 stores data capture instructions 412, data extraction instructions 414, identification instructions 416, stacking instructions 418, issue detection instructions 420, alert instructions 422, as well as other instructions 424, such as an operating system. The computer-readable media 410 may also be configured to store data, such as sensor data 426, machine learned models 428, and stacking data 430 as well as other data.

The data capture instructions 412 may be configured to utilize or activate the sensor systems 404 to capture sensor data 426 associated with an asset, a THU, a region of the facility or transport, or the like. The captured sensor data 426 may then be stored and/or transmitted or streamed to an asset management system, as discussed herein.

The data extraction instructions 414 may be configured to extract, segment, classify objects represented within the sensor data 426. For example, the data extraction instructions 414 may segment and classify each asset present on a THU as well as other objects or features within the sensor data 426, such as individuals and/or vehicles. In some cases, the data extraction instructions 414 may utilize the machine learned models 428 to perform extraction, segmentation, classification, recognition, and the like.

The identification instructions 416 may be configured to determine an identity of an asset, a THU, a region of the facility or transport, or an individual and/or vehicle, and the like. For example, the identification instructions 416 may utilize one or more machine learned models 428 with respect to the sensor data 426 and/or the extracted data to determine the identity of an asset, a THU, a location, and region of the facility or transport, or an individual and/or vehicle, and the like, as discussed above.

The issue detection instructions 418 may be configured to process the sensor data 426 to identify damage or other issues associated with an asset and/or a THU. For example, an asset may have damage, be opened, or otherwise have concerns that may not become apparent until the assets are unloaded from a storage pallet or the like by the stacking system 400. Thus, in some cases, the stacking system 400 may inspect each asset before placing or arranging on the THU for delivery. In some cases, the issue detection instructions 818 may detect damage or other issues using the machine learned models 428 then compare the damage detected with any known damage to determine if the damage was received while the THU was being moved.

The alert instructions 822 may be configured to alert or otherwise notify the asset management system, facility vehicles, vehicle operators, facility operators, managers, insurance carriers, government agencies, and the like in response to completion of a stacking task and/or in response to detecting an issue.

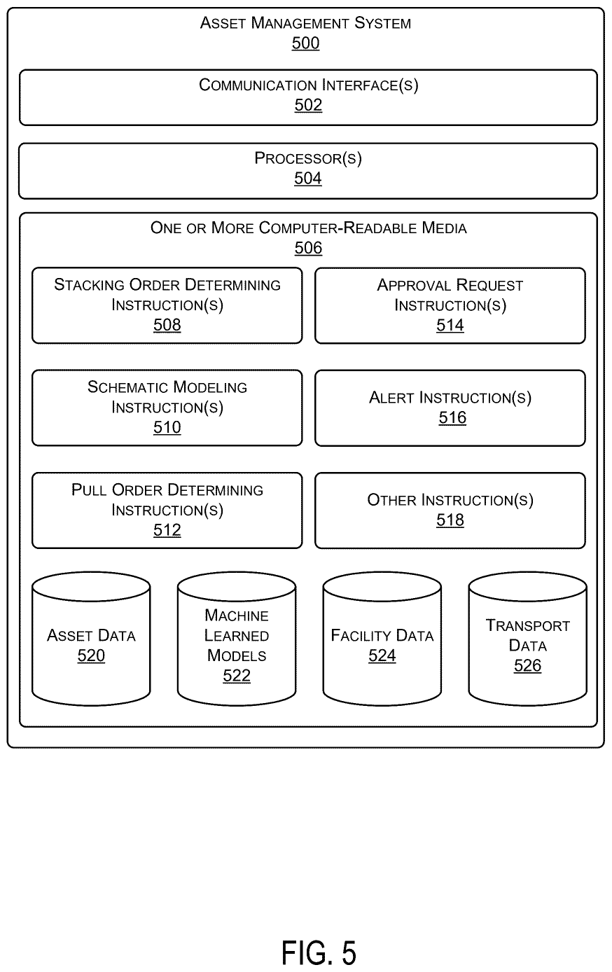

FIG. 5 is an example asset management system 500 that may implement the techniques described herein according to some implementations. The asset management system 500 may include one or more communication interface(s) 502 (also referred to as communication devices and/or modems). The one or more communication interfaces(s) 502 may enable communication between the system 500 and one or more other local or remote computing device(s) or remote services, such as stacking system of FIG. 4. The communications interfaces(s) 502 may enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.), satellite communication, dedicated short-range communications (DSRC), or any suitable wired or wireless communications protocol that enables the respective computing device to interface with the other computing device(s).

The asset management system 500 may include one or more processors 504 and one or more computer-readable media 506. Each of the processors 504 may itself comprise one or more processors or processing cores. The computer-readable media 506 is illustrated as including memory/storage. The computer-readable media 506 may include volatile media (such as random access memory (RAM)) and/or nonvolatile media (such as read only memory (ROM), Flash memory, optical disks, magnetic disks, and so forth). The computer-readable media 506 may include fixed media (e.g., GPU, NPU, RAM, ROM, a fixed hard drive, and so on) as well as removable media (e.g., Flash memory, a removable hard drive, an optical disc, and so forth). The computer-readable media 506 may be configured in a variety of other ways as further described below.

Several modules such as instructions, data stores, and so forth may be stored within the computer-readable media 506 and configured to execute on the processors 504. For example, as illustrated, the computer-readable media 506 stores stacking order determining instructions 508, schematic modeling instructions 510, pull order determining instructions 512, approval request instructions 514, alert instructions 516, as well as other instructions 516, such as an operating system. The computer-readable media 506 may also be configured to store data, such as asset data 520, machine learned models 522, facility data 524, and transport data 526, as well as other data.

The stacking order determining instructions 508 may be configured to determine a stacking order for each THU being prepared for a transport unit to ensure the THU are stacked to avoid damage to any particular asset and to meet requirements as designated by the transport vehicle, such as weight, bounding box, height, and the like. In some cases, the stacking order determining instructions 508 may utilize the asset data 520 together with the facility data 524 and the transport data 526 to assign assets to THU and determine the arrangement of the assets with respect to each other and the assigned THU.

The schematic modeling instructions 510 may be configured to generate a stacking schematic, such as a model or facts, associated with each THU based on the stacking order and/or THU assignment. In some cases, the stacking schematic may be used to seek approval prior to loading the assets on the transport vehicle.

The pull order determining instructions 512 may determine the order for the facility to move the assets from storage to a staging area associated with a stacking system to ensure that the correct or desired assets are at the stacking area when needed by the stacking system.

The approval request instructions 514 may be configured to seek approve for a stacking arrangement form various parties, such as a governmental body, asset owner, purchaser, seller, transport company, driver/operator, or the like.

The alert instructions 516 may be configured to alert or otherwise notify vehicle operators, facility vehicles, facility operators, managers, insurance carriers, government agencies, and the like in response to task completion, transports arriving, departing, and loading status, any delays, any asset issues, and the like.

### Example Clauses

While the example clauses described above are described with respect to one particular implementation, it should be understood that, in the context of this document, the content of the example clauses can also be implemented via a method, device, system, a computer-readable medium, and/or another implementation. Additionally, any of examples may be implemented alone or in combination with any other one or more of the other examples.

1. A method comprising:
receiving first sensor data associated with a stacking event associated with a customer order at a designated stacking area of a facility;
detecting, based at least in part on the first sensor data, a transport handling unit (THU) within the stacking area;
detecting, based at least in part on the first sensor data, two or more assets within the stacking area, the two or more assets included on a customer order being fulfilled;
causing, based at least in part on transport data associated with a transport vehicle assigned to fulfill the customer order and asset data associated with the two or more assets, an autonomous system associated with the stacking area to arrange the two or more items with respect to the THU;
receiving second sensor data associated with the stacking area;
determining, based at least in part on the second sensor data, that the stacking event is complete; and
responsive to determining the stacking event is complete, sending a notification to a device, the notification indicating that the THU is ready to load on the transport vehicle.

2. The method of claim 1, further comprising determining, based at least in part on the transport data and the asset data, a stacking order associated with the stacking event.

3. The method of claim 2, wherein the stacking order is based at least in part on a dimension or weight associated with individual ones of the two or more assets.

4. The method of claim 3, further comprising determining, based at least in part on the stacking order, a stacking schematic associated with the THU and the two or more assets of the stacking event.

5. The method of the claim 4, further comprising:
sending the stacking schematic to a remote device for approval; and
receiving the approval from the remote device prior to causing the autonomous system to arrange the two or more items with respect to the THU.

6. The method of claim 4, wherein the stacking schematic is a three-dimensional representation of the THU after the stacking event is completed.

7. The method of claim 4, further comprising displaying the stacking schematic on a display associated with the stacking area,

8. The method of claim 1, further comprising generating, based at least in part on the stacking order, a pull order associated with the two or more assets, the pull order associated with an order from which to collect the two or more assets from a storage area of the facility.

9. The method of claim 1, further comprising sending the pull order to a facility vehicle to collect the two or more assets from the storage area.

10. The method of the claim 9, wherein:
the facility vehicle is an autonomous vehicle; and
sending the pull order to the facility vehicle further comprises causing the facility vehicle to collect the two or more assets and deliver the two or more assets to the stacking area.

11. The method of claim 1, wherein:
detecting the THU and the two or more assets further comprises inputting the first sensor data into one or more first machine learned models to segment and classify the first sensor data and to output features associated with the THU and the two or more assets;
determining the stacking order further comprises inputting the asset data and the transport data into one or more second machine learned models that outputs the stacking order, the one or more second machine learned model trained on asset data and training transport data associated with prior customer orders; and
determining the pull order or the stacking order further comprises inputting the stacking order into one or more third machine learned models that outputs the pull order, the one or more third machine learned model trained on stacking order data associated with the prior customer orders.

12. The method of claim 1, further comprising generating, based at least in part on the stacking order, a pull order associated with the two or more assets, the pull order associated with an order from which to collect the two or more assets from a storage area of the facility.

13. A system comprising:
one or more processors; and
one or more non-transitory computer readable media storing instructions executable by the one or more processors, wherein the instructions, when executed, cause the one or more processors to perform operations comprising:
receiving asset data associated with a customer order;
determining, based at least in part on the asset data, a stacking order associated with a fulfillment of the customer order;
determining, based at least in part on the stacking order, a pull order associated with two or more assets included in the customer order;
causing a facility vehicle to collect the two or more items based at least in part on the pull order; and
causing a stacking system to arrange the two or more items on a transport handling unit (THU) based at least in part on the stacking order.

14. The system of claim 13, wherein the operations further comprise:
determining, based at least in part on the stacking order, a stacking schematic associated with two or more assets included in the customer order;
sending the stacking schematic to a remote system;
receiving an approval from the remote system; and
wherein causing the stacking system to arrange the two or more items on the THU is responsive to receiving the approval.

15. The system of claim 14, wherein the remote system is at least one of a system associated with a transport vehicle fulfilling the customer order, a system associated with a customer placing the customer order, or a system associated with a government agency.

16. One or more non-transitory computer readable media storing instructions executable by the one or more processors, wherein the instructions, when executed, cause the one or more processors to perform operations comprising:
receiving first sensor data associated with a stacking event associated with a customer order at a designated stacking area of a facility;
detecting, based at least in part on the first sensor data, a transport handling unit (THU) within the stacking area;
detecting, based at least in part on the first sensor data, two or more assets within the stacking area, the two or more assets included on a customer order being fulfilled;
causing, based at least in part on transport data associated with a transport vehicle assigned to fulfill the customer order and asset data associated with the two or more assets, an autonomous system associated with the stacking area to arrange the two or more items with respect to the THU;
receiving second sensor data associated with the stacking area;
determining, based at least in part on the second sensor data, that the stacking event is complete; and
responsive to determining the stacking event is complete, sending a notification to a device, the notification indicating that the THU is ready to load on the transport vehicle.

17. The one or more non-transitory computer readable media of claim 16, wherein the operations further comprise determining, based at least in part on the transport data and the asset data, a stacking order associated with the stacking event.

18. The one or more non-transitory computer readable media of claim 16, wherein the stacking order is based at least in part on a dimension or weight associated with individual ones of the two or more assets.

19. The one or more non-transitory computer readable media of claim 18, wherein the operations further comprise:
determining, based at least in part on the stacking order, a stacking schematic associated with the THU and the two or more assets of the stacking event;
sending the stacking schematic to a remote device for approval; and
receiving the approval from the remote device prior to causing the autonomous system to arrange the two or more items with respect to the THU.

20. The method of claim 1, wherein:
detecting the THU and the two or more assets further comprises inputting the first sensor data into one or more first machine learned models to segment and classify the first sensor data and to output features associated with the THU and the two or more assets;
determining the stacking order further comprises inputting the asset data and the transport data into one or more second machine learned models that outputs the stacking order, the one or more second machine learned model trained on asset data and training transport data associated with prior customer orders; and
determining the pull order or the stacking order further comprises inputting the stacking order into one or more third machine learned models that outputs the pull order, the one or more third machine learned model trained on stacking order data associated with the prior customer orders.
